(19) United States
(12) Patent Application Publication
(10) Pub. No.: US 2010/0129546 A1
(43) Pub. Date: May 27, 2010

(54) PROTECTIVE FILM FORMING METHOD AND APPARATUS

(75) Inventors: Nobuyasu Kitahara, Ota-ku (JP); Tomoaki Endo, Ota-ku (JP); Yukito Akutagawa, Ota-ku (JP)

Correspondence Address: GREER, BURNS & CRAIN, 300 S WACKER DR, 25TH FLOOR, CHICAGO, IL, 60606, US

(73) Assignee: DISCO CORPORATION, Tokyo (JP)

(21) Appl. No.: 12/579,457

(22) Filed: Oct. 15, 2009

(30) Foreign Application Priority Data
Nov. 25, 2008 (JP) 2008-299536

(51) Int. Cl. B05D 3/12; B05C 13/02

(52) U.S. Cl. 427/240; 118/52

(57) ABSTRACT

A protective film forming method for forming a protective film of resin on a work surface of a wafer. The protective film forming method includes a wafer holding step of holding the wafer on a spinner table in the condition where the work surface is oriented upward, a spray coating step of spraying first liquid resin onto the work surface of the wafer as rotating the spinner table at a first rotational speed after performing the wafer holding step, a liquid resin supplying step of dropping a predetermined amount of second liquid resin onto a central area of the work surface of the wafer as rotating the spinner table at a second rotational speed lower than the first rotational speed after performing the spray coating step, and a spin coating step of rotating the spinner table at a third rotational speed higher than the first rotational speed after performing the liquid resin supplying step to thereby spread the second liquid resin dropped onto the central area of the work surface of the wafer, thus forming the protective film on the work surface of the wafer.

### BACKGROUND OF THE INVENTION

1. Field of the Invention

The present invention relates to a protective film forming method and apparatus for forming a protective film of resin on the front side of a wafer such as a semiconductor wafer and an optical device wafer.

2. Description of the Related Art

In a semiconductor device fabrication process, a plurality of crossing streets (division lines) are formed on the front side of a substantially disk-shaped semiconductor wafer to partition a plurality of areas where devices such as ICs, LSIs, liquid crystal drivers, and flash memories are respectively formed. The wafer is cut along the streets to divide these areas from each other along the streets, thereby producing the individual devices. Further, in an optical device wafer, the front side of a sapphire substrate or the like is partitioned into a plurality of areas by a plurality of crossing streets, and a gallium nitride compound semiconductor or the like is layered in each of these partitioned areas to thereby form an optical device. Such an optical device wafer is cut along the streets into a plurality of optical devices such as light emitting diodes and laser diodes, which are widely used for electrical equipment.

As a method of dividing a wafer such as a semiconductor wafer and an optical device wafer along the streets, there has been proposed a method including the steps of applying a pulsed laser beam to the wafer along the streets to thereby form a plurality of laser processed grooves and next breaking the wafer along these laser processed grooves by using a mechanical breaking apparatus (see Japanese Patent Laid-open No. Hei 10-305420, for example).

Such laser processing has advantages over cutting such that a processing speed is higher and a wafer formed of a hard material such as sapphire can be processed relatively easily. However, when a laser beam is applied to the wafer along the streets, thermal energy is concentrated at a region irradiated with the laser beam, causing the generation of debris, and this debris may stick to bonding pads connected to the circuits, causing a degradation in quality of the chips. To solve this problem due to the debris, there has been proposed a laser processing method including the steps of coating the work surface of a wafer with a protective film formed of resin such as polyvinyl alcohol and next applying a laser beam through the protective film to the work surface of the wafer (see Japanese Patent Laid-open No. 2004-322168, for example).

Japanese Patent Laid-open No. 2004-322168 mentioned above discloses a spinner coating method including the steps of dropping a predetermined amount of liquid resin from a liquid resin supply nozzle to a central portion of a wafer held on a spinner table and rotating the spinner table at 3000 rpm, for example, thereby forming a protective film on the work surface of the wafer. However, since the affinity of the liquid resin such as polyvinyl alcohol to the wafer is low, the work surface of the wafer is partially uncoated with the liquid resin, so that it is difficult to form a protective film having a uniform thickness on the work surface of the wafer. Further, since the spinner table is rotated at a high speed of 3000 rpm, for example, 99% of the liquid resin dropped onto the work surface of the wafer scatters to be wasted. For example, in the case that 30 mL of polyvinyl alcohol is dropped onto the work surface of a wafer having a diameter of 300 mm and the spinner table is rotated at 3000 rpm for 15 seconds, a protective film having a thickness of 5 μm is formed on the work surface of the wafer. In this case, the proportion of the amount of polyvinyl alcohol formed into the protective film to the amount of polyvinyl alcohol dropped onto the work surface of the wafer is merely 1%. That is, 99% of the polyvinyl alcohol supplied is wasted.

### SUMMARY OF THE INVENTION

It is therefore an object of the present invention to provide a protective film forming method and apparatus which can form a protective film having a uniform thickness from liquid resin on the front side (work surface) of a wafer and can reduce the amount of usage of the liquid resin.

In accordance with an aspect of the present invention, there is provided a protective film forming method for forming a protective film of resin on a work surface of a wafer, comprising a wafer holding step of holding the wafer on a spinner table in the condition where the work surface is oriented upward; a spray coating step of spraying first liquid resin onto the work surface of the wafer as rotating the spinner table at a first rotational speed after performing the wafer holding step; a liquid resin supplying step of dropping a predetermined amount of second liquid resin onto a central area of the work surface of the wafer as rotating the spinner table at a second rotational speed lower than the first rotational speed after performing the spray coating step; and a spin coating step of rotating the spinner table at a third rotational speed higher than the first rotational speed after performing the liquid resin supplying step to thereby spread the second liquid resin dropped onto the central area of the work surface of the wafer, thus forming the protective film on the work surface of the wafer.

Preferably, the spray coating step is performed under the conditions where the first liquid resin has a viscosity of 3 to 5 cp, the first liquid resin is sprayed at a rate of 0.04 to 0.06 mL/sec for 60 to 90 seconds, and the first rotational speed of the spinner table is set to 50 to 70 rpm; the liquid resin supplying step is performed under the conditions where the second liquid resin has a viscosity of 50 to 70 cp, the second liquid resin is dropped at a rate of 4 to 6 mL/sec for two to four seconds, and the second rotational speed of the spinner table is set to 5 to 15 rpm; and the spin coating step is performed under the conditions where the third rotational speed of the spinner table is set to 400 to 600 rpm and the duration time is set to 20 to 40 seconds.

Preferably, the protective film forming method further comprises a spin drying step of rotating the spinner table at 2000 to 3000 rpm for 50 to 70 seconds after performing the spin coating step to thereby dry the protective film formed on the work surface of the wafer.

In accordance with another aspect of the present invention, there is provided a protective film forming apparatus for forming a protective film of resin on a work surface of a wafer, comprising a spinner table for holding the wafer thereon; rotational driving means for rotating the spinner table; spraying means for spraying first liquid resin onto the work surface of the wafer held on the spinner table; and liquid resin supplying means for dropping second liquid resin onto a central area of the work surface of the wafer held on the spinner table.

The protective film forming method according to the present invention includes the spray coating step, the liquid resin supplying step, and the spin coating step. By performing the spray coating step prior to the spin coating step, the affinity of the second liquid resin to the work surface of the wafer in the spin coating step can be improved. Accordingly, although the rotational speed of the spinner table holding the wafer thereon in the spin coating step is set lower than that in the conventional method mentioned above, the protective film can be uniformly formed on the work surface of the wafer. Accordingly, the rate of contribution of the second liquid resin to the protective film can be improved to thereby reduce the amount of usage of the second liquid resin.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a laser processing system including a protective film forming apparatus according to a preferred embodiment of the present invention;

FIG. 2 is a partially cutaway perspective view of the protective film forming apparatus included in the laser processing system shown in FIG. 1;

FIG. 3 is a vertical sectional view of the protective film forming apparatus in the condition where a spinner table included therein is lifted to a work load/unload position;

FIG. 4 is a vertical sectional view of the protective film forming apparatus in the condition where the spinner table is lowered to a working position;

FIG. 5 is a diagrammatic sectional view showing an essential part of spraying means included in the protective film forming apparatus;

FIG. 6 is a diagrammatic sectional view showing an essential part of liquid resin supplying means included in the protective film forming apparatus;

FIG. 7 is a partially cutaway perspective view of cleaning means included in the laser processing system shown in FIG. 1;

FIG. 8 is a vertical sectional view of the cleaning means in the condition where a spinner table included therein is lifted to a work load/unload position;

FIG. 9 is a vertical sectional view of the cleaning means in the condition where the spinner table is lowered to a working position;

FIG. 10 is a perspective view of a semiconductor wafer as a workpiece to be processed by the laser processing system shown in FIG. 1;

FIG. 11 is a plan view for illustrating a spray coating step to be performed by the protective film forming apparatus included in the laser processing system shown in FIG. 1;

FIG. 12 is a plan view for illustrating a liquid resin supplying step to be performed by the protective film forming apparatus included in the laser processing system shown in FIG. 1;

FIG. 13 is an enlarged sectional view of an essential part of the semiconductor wafer obtained by performing a spin coating step to form a protective film on the semiconductor wafer by the protective film forming apparatus included in the laser processing system shown in FIG. 1;

FIGS. 14A and 14B are schematic views for illustrating a laser beam applying step by the laser processing system in FIG. 1; and

FIG. 15 is an enlarged sectional view of an essential part of the semiconductor wafer processed by the laser beam applying step shown in FIGS. 14A and 14B.

### DETAILED DESCRIPTION OF THE PREFERRED EMBODIMENTS

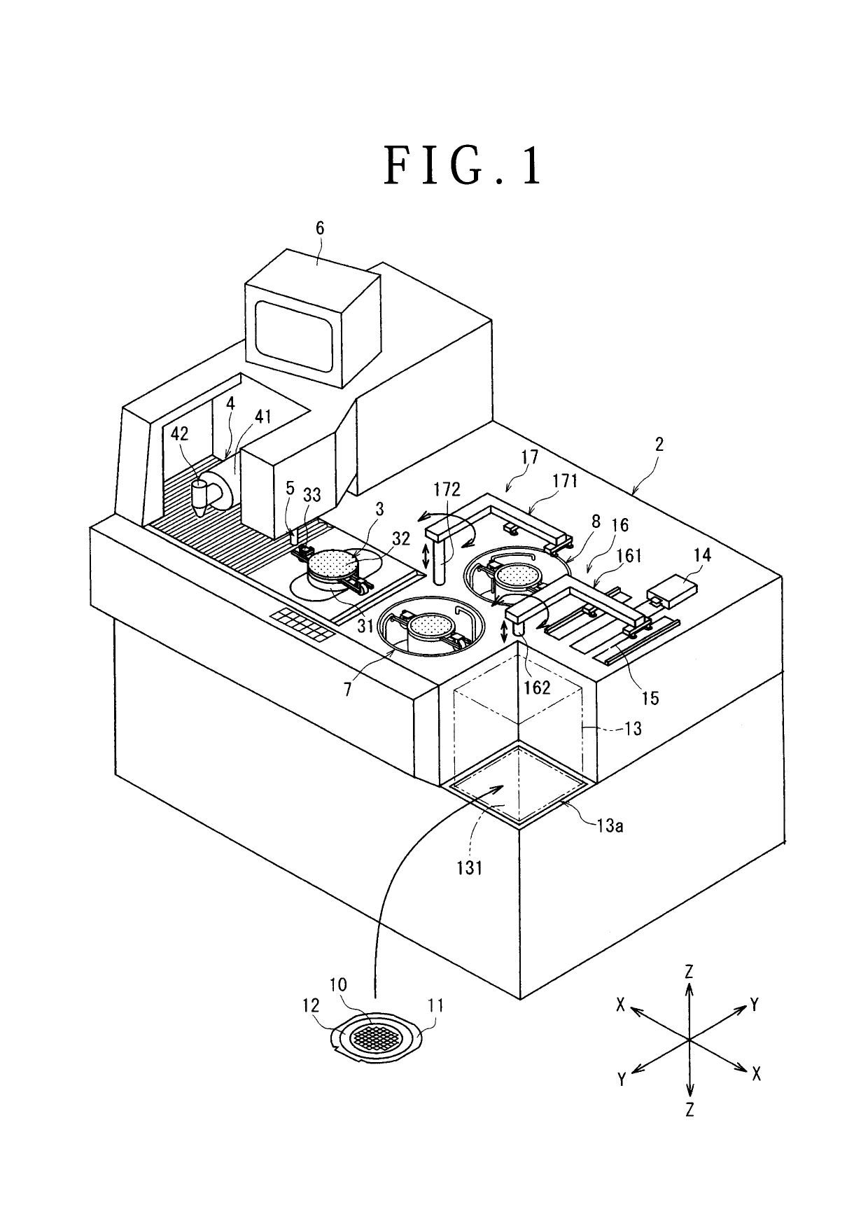

A preferred embodiment of the protective film forming method and apparatus according to the present invention will now be described in detail with reference to the attached drawings. Referring to FIG. 1, there is shown a perspective view of a laser processing system including the protective film forming apparatus according to the present invention.

The laser processing system shown in FIG. 1 has a substantially boxlike housing 2. The housing 2 contains a chuck table 3 as work holding means for holding a workpiece. The chuck table 3 is movable in the direction shown by an arrow X as a work feeding direction. The chuck table 3 has a vacuum chuck support 31 and a vacuum chuck 32 mounted on the vacuum chuck support 31. The vacuum chuck 32 has an upper surface for placing a workpiece such as a disk-shaped semiconductor wafer thereon. The workpiece placed on the upper surface of the vacuum chuck 32 is held by suction means not shown. Further, the chuck table 3 is rotatable by a rotating mechanism not shown. The vacuum chuck support 31 of the chuck table 3 is provided with a pair of clamps 33 for fixing an annular frame for a disk-shaped semiconductor wafer to be hereinafter described.

The laser processing system shown in FIG. 1 includes laser beam applying means 4 for applying a laser beam to the workpiece held on the vacuum chuck 32 of the chuck table 3. The laser beam applying means 4 includes a cylindrical casing 41 extending in a substantially horizontal direction. Although not shown, the casing 41 contains pulsed laser beam oscillating means including a pulsed laser beam oscillator and repetition frequency setting means. Examples of the pulsed laser beam oscillator include a YAG laser oscillator and a YVO4 laser oscillator. The laser beam applying means 4 further includes focusing means 42 for focusing the laser beam oscillated by the pulsed laser beam oscillating means. The focusing means 42 is mounted on the front end of the casing 41.

The laser processing system shown in FIG. 1 further includes imaging means 5 for imaging the upper surface of the workpiece held on the vacuum chuck 32 of the chuck table 3 to detect a region to be processed by the laser beam applied from the focusing means 42 of the laser beam applying means 4. The imaging means 5 includes an ordinary imaging device (CCD) for imaging the workpiece by using visible light, infrared light applying means for applying infrared light to the workpiece, an optical system for capturing the infrared light applied by the infrared light applying means, and an imaging device (infrared CCD) for outputting an electrical signal corresponding to the infrared light captured by the optical system. An image signal output from the imaging means 5 is transmitted to control means not shown. The laser processing system shown in FIG. 1 further includes displaying means 6 for displaying the image obtained by the imaging means 5.

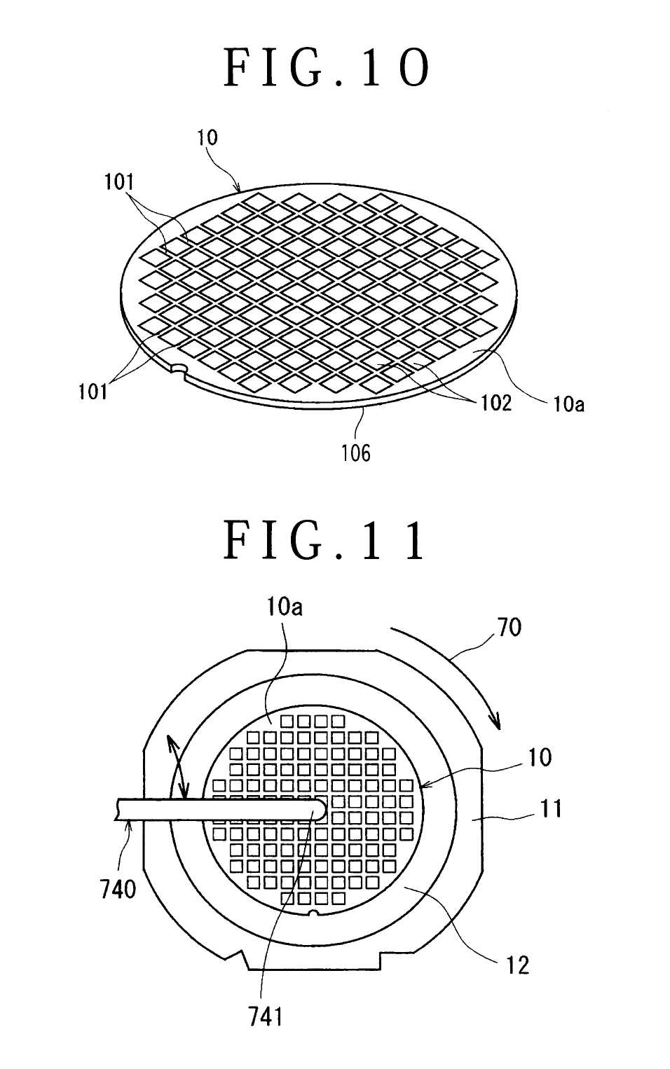

The laser processing system shown in FIG. 1 further includes a cassette setting portion 13a for setting a cassette 13 storing a semiconductor wafer 10 as a workpiece to be processed. The cassette setting portion 13a is provided with a cassette table 131 vertically movable by lifting means not shown. The cassette 13 is set on the cassette table 131. The semiconductor wafer 10 is attached to the upper surface of a protective tape 12 supported to an annular frame 11. Thus, the semiconductor wafer 10 supported through the protective tape 12 to the annular frame 11 is stored in the cassette 13. For example, the semiconductor wafer 10 is provided by a silicon wafer having a diameter of 300 mm. As shown in FIG. 10, the semiconductor wafer 10 has a front side 10a and a back side 10b. The front side 10a of the semiconductor wafer 10 is partitioned into a plurality of rectangular regions by a plurality of crossing streets 101, wherein a plurality of individual devices 102 such as ICs and LSIs are respectively formed in these plural rectangular regions. The back side 10b of the semiconductor wafer 10 is attached to the upper surface of the protective tape 12 supported to the annular frame 11 in the condition where the front side 10a of the semiconductor wafer 10 is oriented upward as shown in FIG. 1.

The laser processing system shown in FIG. 1 further includes work ejecting/inserting means 14 for ejecting the semiconductor wafer 10 from the cassette 13 before processing and inserting the semiconductor wafer 10 into the cassette 13 after processing, a temporary setting table 15 for temporarily setting the semiconductor wafer 10 ejected by the work ejecting/inserting means 14 before processing, a protective film forming apparatus 7 for forming a protective film on the work surface of the semiconductor wafer 10 before processing, the protective film forming apparatus 7 being provided in a first carrying path where the semiconductor wafer 10 is carried from the temporary setting table 15 to the chuck table 3 before processing, and cleaning means 8 for cleaning off the protective film formed on the work surface of the semiconductor wafer 10 after processing, the cleaning means 8 being provided in a second carrying path where the semiconductor wafer 10 is carried from the chuck table 3 to the temporary setting table 15 after processing.

The laser processing system shown in FIG. 1 further includes first carrying means 16 for carrying the semiconductor wafer 10 from the temporary setting table 15 to the protective film forming apparatus 7 before processing and for carrying the semiconductor wafer 10 from the cleaning means 8 to the temporary setting table 15 after processing, and second carrying means 17 for carrying the semiconductor wafer 10 from the protective film forming apparatus 7 to the chuck table 3 before processing and for carrying the semiconductor wafer 10 from the chuck table 3 to the cleaning means 8 after processing.

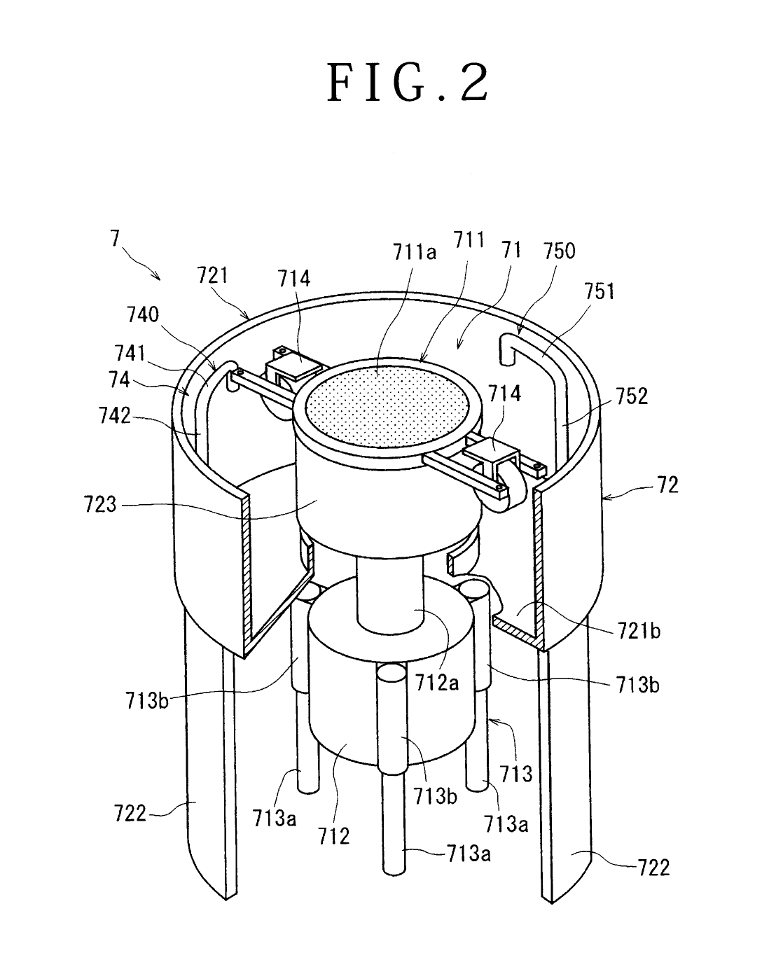

The protective film forming apparatus 7 will now be described with reference to FIGS. 2 to 4. The protective film forming apparatus 7 includes a spinner table mechanism 71 and spinner table accommodating means 72 provided so as to surround the spinner table mechanism 71. The spinner table mechanism 71 includes a spinner table 711, an electric motor 712 for rotationally driving the spinner table 711, and a support mechanism 713 for vertically movably supporting the electric motor 712. The spinner table 711 includes a vacuum chuck 711a formed of a porous material. The vacuum chuck 711a is connected to suction means not shown. Accordingly, the spinner table 711 functions to hold the semiconductor wafer 10 as a workpiece placed on the vacuum chuck 711a by using a vacuum produced by the suction means.

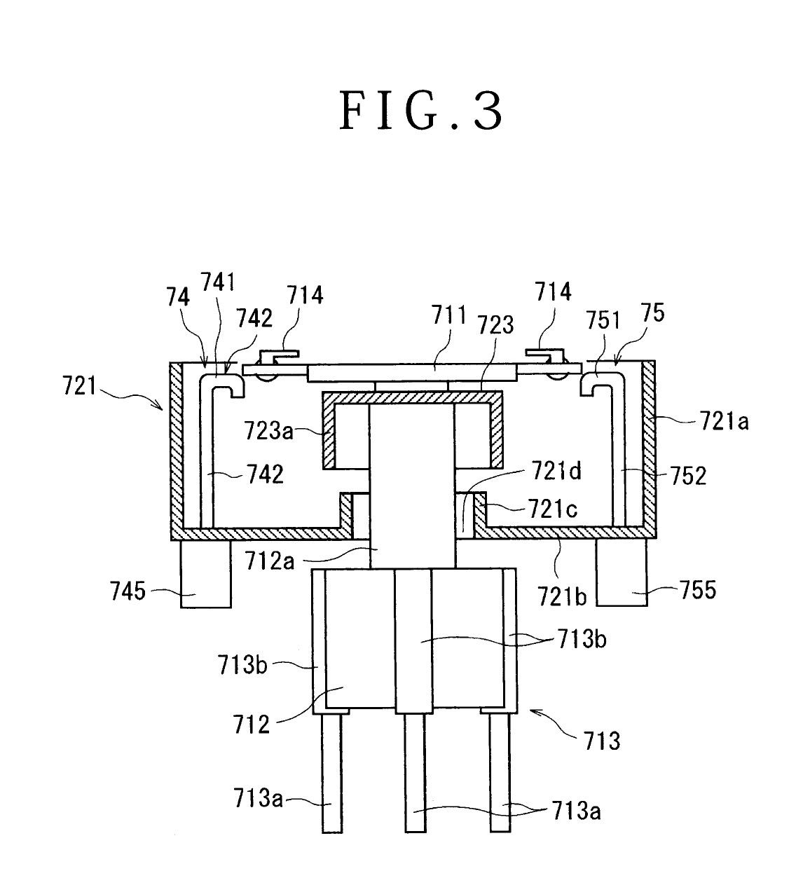

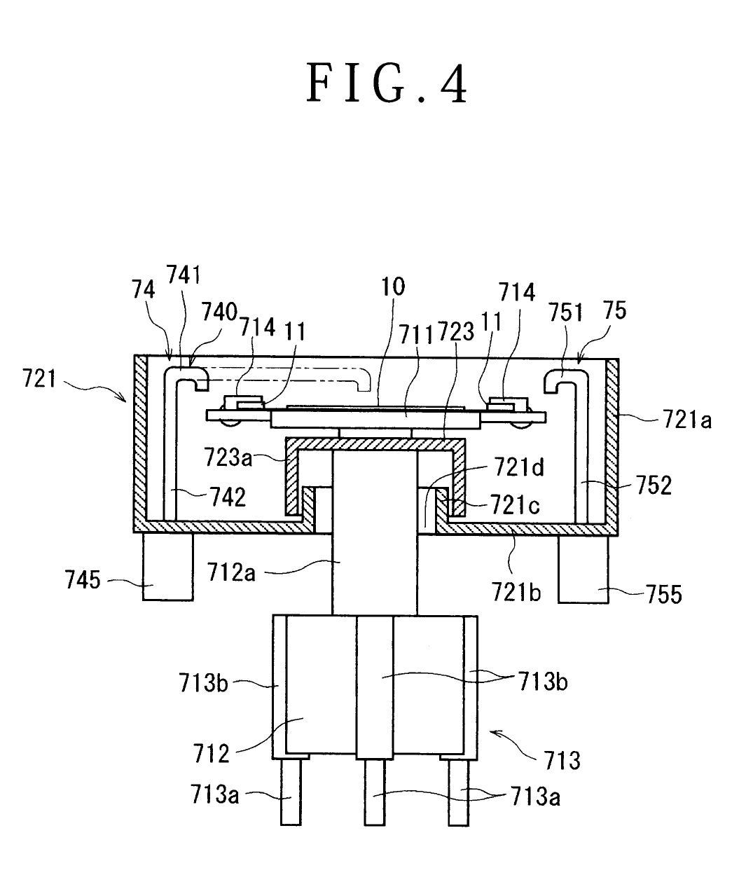

The spinner table 711 is provided with a pair of clamps 714 for fixing the annular frame 11 supporting the semiconductor wafer 10. The electric motor 712 has a drive shaft 712a, and the spinner table 711 is connected to the upper end of the drive shaft 712a. The support mechanism 713 is composed of a plurality of (three in this preferred embodiment) support legs 713a and a plurality of (three in this preferred embodiment) air cylinders 713b operatively connected to the support legs 713a, respectively. All of the air cylinders 713b are mounted on the electric motor 712. The support mechanism 713 functions in such a manner that the air cylinders 713b are operated to vertically move the electric motor 712 and the spinner table 711 between the upper position shown in FIG. 3 as a work load/unload position and the lower position shown in FIG. 4 as a working position.

The spinner table accommodating means 72 includes a receptacle 721, three support legs 722 for supporting the receptacle 721 (two of the three support legs 722 being shown in FIG. 2), and a cover member 723 mounted on the drive shaft 712a of the electric motor 712. As shown in FIGS. 3 and 4, the receptacle 721 is composed of a cylindrical outer wall 721a, a bottom wall 721b, and a cylindrical inner wall 721c. The bottom wall 721b is formed with a central hole 721d for allowing the insertion of the drive shaft 712a of the electric motor 712. The cylindrical inner wall 721c projects upward from the peripheral edge of the central hole 721d. The cover member 723 is a cylindrical member having a closed top. The closed top of the cover member 723 is mounted to the upper end portion of the drive shaft 712a of the electric motor 712, and a covering portion 723a projects downward from the outer circumference of the closed top of the cover member 723. In the working position of the electric motor 712 and the spinner table 711 as shown in FIG. 4, the covering portion 723a of the cover member 723 is located so as to surround the cylindrical inner wall 721c of the receptacle 721 with a given gap defined therebetween.

The protective film forming apparatus 7 further includes spraying means 74 for spraying first liquid resin onto the front side 10a (work surface) of the semiconductor wafer 10 as a workpiece held on the spinner table 711 before processing. The spraying means 74 includes a spray nozzle 740 for spraying the first liquid resin toward the work surface of the wafer held on the spinner table 711 before processing. The spray nozzle 740 is composed of a horizontally extending nozzle portion 741 having a downward bent front end and a support portion 742 extending downward from the base end of the nozzle portion 741. The support portion 742 is inserted through a hole (not shown) formed through the bottom wall 721b of the receptacle 721.

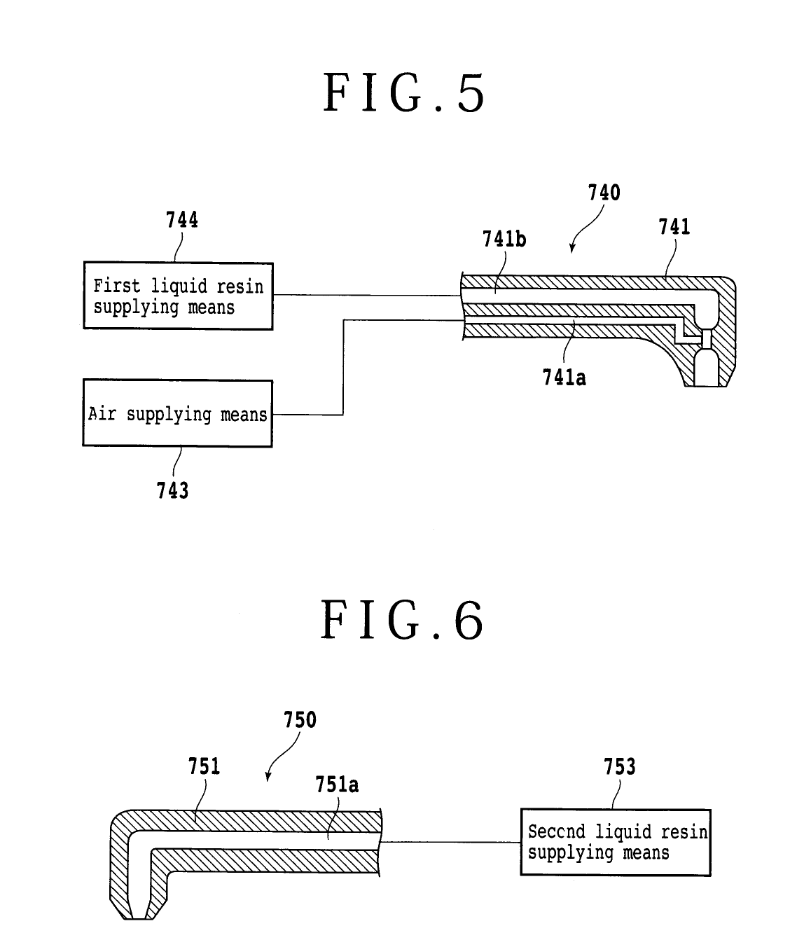

As shown in FIG. 5, the nozzle portion 741 of the spray nozzle 740 includes a liquid resin passage 741a and an air passage 741b. The liquid resin passage 741a is connected to first liquid resin supplying means 743, and the air passage 741b is connected to air supplying means 744. The first liquid resin supplying means 743 functions to supply polyvinyl alcohol as the first liquid resin. This polyvinyl alcohol as the first liquid resin preferably has a viscosity of 3 to 5 centipoise (cp). For example, this viscosity is set to 3.8 cp in this preferred embodiment. The air supplying means 744 functions to supply air under a pressure of 0.4 MPa, for example. Although not shown, a seal member is mounted to the peripheral edge of the insert hole not shown for allowing the insertion of the support portion 742 of the spray nozzle 740, thereby sealing the gap between the support portion 742 and the bottom wall 721b. The spraying means 74 further includes a reversible electric motor 745 for horizontally swinging the spray nozzle 740. The reversible electric motor 745 is configured so as to rotate the support portion 742 of the spray nozzle 740 in opposite directions.

The protective film forming apparatus 7 further includes liquid resin supplying means 75 for dropping second liquid resin onto a central area of the front side 10a (work surface) of the semiconductor wafer 10 held on the spinner table 711 before processing. The liquid resin supplying means 75 includes a liquid resin supply nozzle 750 for supplying the second liquid resin toward the work surface of the wafer held on the spinner table 711 before processing. The liquid resin supply nozzle 750 is composed of a horizontally extending nozzle portion 751 having a downward bent front end and a support portion 752 extending downward from the base end of the nozzle portion 751. The support portion 752 is inserted through a hole (not shown) formed through the bottom wall 721b of the receptacle 721.

As shown in FIG. 6, the nozzle portion 751 of the liquid resin supply nozzle 750 includes a liquid resin passage 751a. The liquid resin passage 751a is connected to second liquid resin supply means 753. The second liquid resin supplying means 753 functions to supply polyvinyl alcohol as the second liquid resin. This polyvinyl alcohol as the second liquid resin preferably has a viscosity of 50 to 70 cp. For example, this viscosity is set to 60 cp in this preferred embodiment. Although not shown, a seal member is mounted to the peripheral edge of the insert hole not shown for allowing the insertion of the support portion 752 of the liquid resin supply nozzle 750, thereby sealing the gap between the support portion 752 and the bottom wall 721b. The liquid resin supplying means 75 further includes a reversible electric motor 755 for horizontally swinging the liquid resin supply nozzle 750. The reversible electric motor 755 is configured so as to rotate the support portion 752 of the liquid resin supply nozzle 750 in opposite directions.

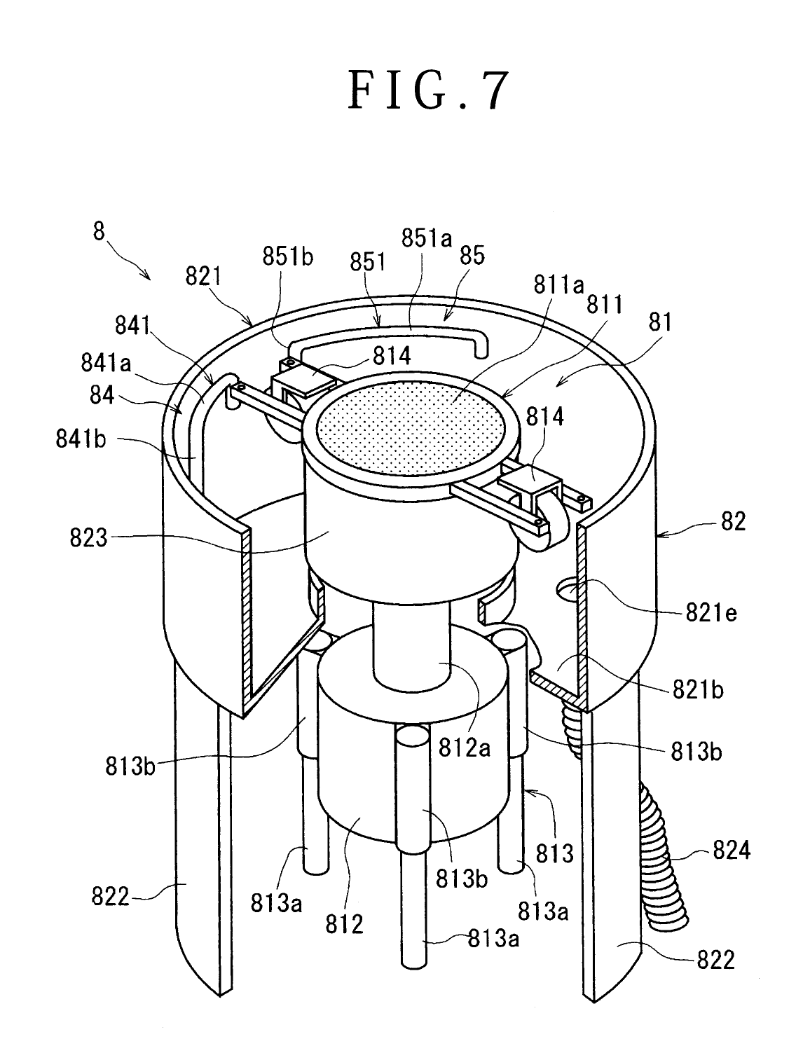

The cleaning means 8 will now be described with reference to FIGS. 7 to 9. The cleaning means 8 includes a spinner table mechanism 81 and cleaning water receiving means 82 provided so as to surround the spinner table mechanism 81. The spinner table mechanism 81 is similar to the spinner table mechanism 71 of the protective film forming apparatus 7. That is, the spinner table mechanism 81 includes a spinner table 811, an electric motor 812 for rotationally driving the spinner table 811, and a support mechanism 813 for vertically movably supporting the electric motor 812. The spinner table 811 includes a vacuum chuck 811a formed of a porous material. The vacuum chuck 811a is connected to suction means not shown. Accordingly, the spinner table 811 functions to hold the semiconductor wafer 10 as a workpiece placed on the vacuum chuck 811a by using a vacuum produced by the suction means not shown.

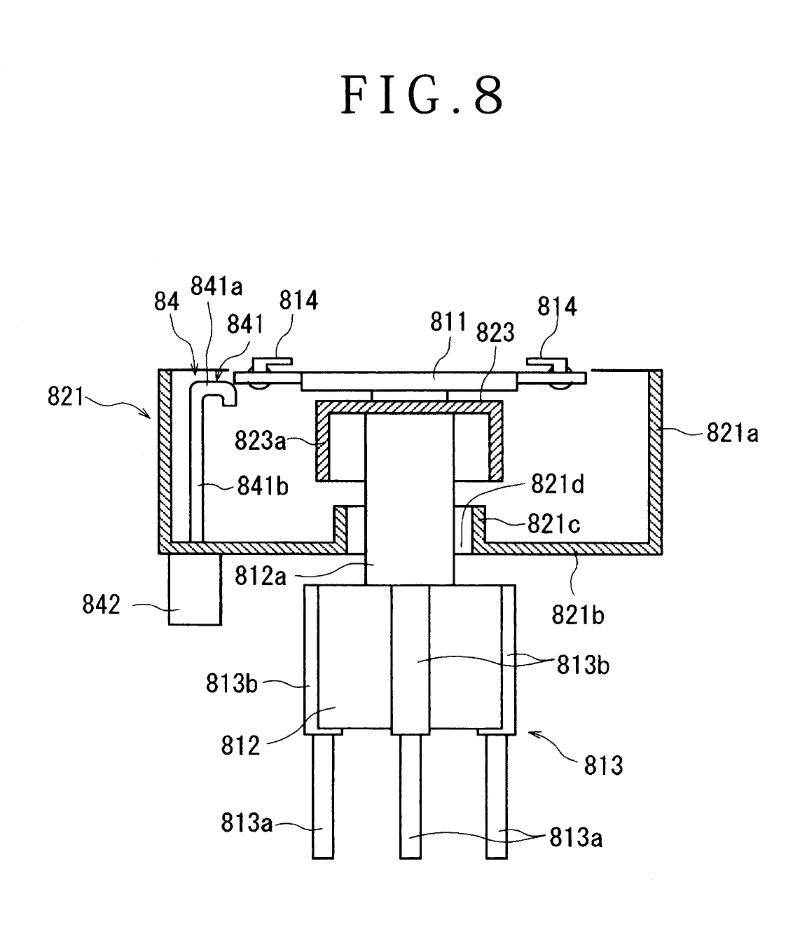

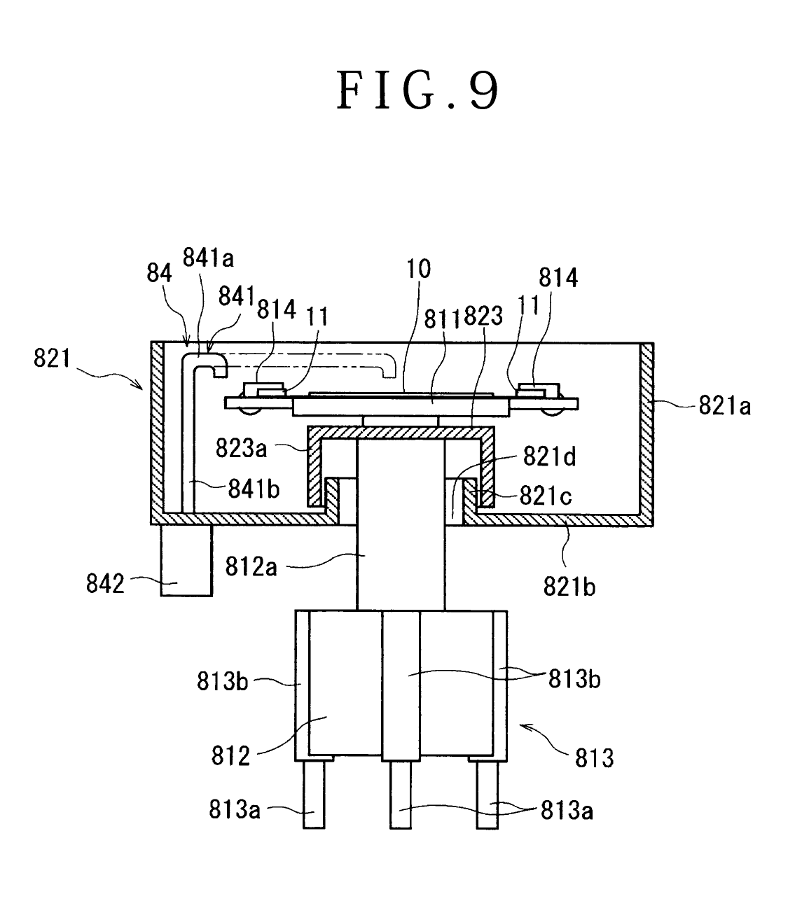

The spinner table 811 is provided with a pair of clamps 814 for fixing the annular frame 11 supporting the semiconductor wafer 10. The electric motor 812 has a drive shaft 812a, and the spinner table 811 is connected to the upper end of the drive shaft 812a. The support mechanism 813 is composed of a plurality of (three in this preferred embodiment) support legs 813a and a plurality of (three in this preferred embodiment) air cylinders 813b operatively connected to the support legs 813a, respectively. All of the air cylinders 813b are mounted on the electric motor 812. The support mechanism 813 functions in such a manner that the air cylinders 813b are operated to vertically move the electric motor 812 and the spinner table 811 between the upper position shown in FIG. 8 as a work load/unload position and the lower position shown in FIG. 9 as a working position.

The cleaning water receiving means 82 includes a cleaning water receptacle 821, three support legs 822 for supporting the cleaning water receptacle 821 (two of the three support legs 822 being shown in FIG. 7), and a cover member 823 mounted on the drive shaft 812a of the electric motor 812. As shown in FIGS. 7 and 8, the cleaning water receptacle 821 is composed of a cylindrical outer wall 821a, a bottom wall 821b, and a cylindrical inner wall 821c. The bottom wall 821b is formed with a central hole 821d for allowing the insertion of the drive shaft 812a of the electric motor 812. The cylindrical inner wall 821c projects upward from the peripheral edge of the central hole 821d. As shown in FIG. 7, the bottom wall 821b is formed with a waste fluid outlet 821e, and a drain hose 824 is connected to the waste fluid outlet 821e. The cover member 823 is a cylindrical member having a closed top. The closed top of the cover member 823 is mounted to the upper end portion of the drive shaft 812a of the electric motor 812, and a covering portion 823a projects downward from the outer circumference of the closed top of the cover member 823. In the working position of the electric motor 812 and the spinner table 811 as shown in FIG. 9, the covering portion 823a of the cover member 823 is located so as to surround the cylindrical inner wall 821c of the cleaning water receptacle 821 with a given gap defined therebetween.

The cleaning means 8 further includes cleaning water supplying means 84 for cleaning the wafer held on the spinner table 811 after processing. The cleaning water supplying means 84 includes a cleaning water nozzle 841 for supplying a jet of cleaning water toward the wafer held on the spinner table 811 after processing and a reversible electric motor 842 for horizontally swinging the cleaning water nozzle 841. The cleaning water nozzle 841 is connected to a cleaning water supply source not shown. The cleaning water nozzle 841 is composed of a horizontally extending nozzle portion 841a having a downward bent front end and a support portion 841b extending downward from the base end of the nozzle portion 841a. The support portion 841b is inserted through a hole (not shown) formed through the bottom wall 821b of the cleaning water receptacle 821 and is connected to the cleaning water supply source not shown. Although not shown, a seal member is mounted to the peripheral edge of this hole not shown for allowing the insertion of the support portion 841b of the cleaning water nozzle 841, thereby sealing the gap between the support portion 841b and the bottom wall 821b.

The cleaning means 8 further includes air supplying means 85 for supplying a jet of air toward the wafer held on the spinner table 811 after cleaning with the cleaning water mentioned above. The air supplying means 85 includes an air nozzle 851 for supplying a jet of air toward the wafer held on the spinner table 811 and a reversible electric motor (not shown) for horizontally swinging the air nozzle 851. The air nozzle 851 is connected to an air supply source not shown. The air nozzle 851 is composed of a horizontally extending nozzle portion 851a having a downward bent front end (discharge opening) and a support portion 851b extending downward from the base end of the nozzle portion 851a. The support portion 851b is inserted through a hole (not shown) formed through the bottom wall 821b of the cleaning water receptacle 821 and is connected to the air supply source. Although not shown, a seal member is mounted to the peripheral edge of this hole not shown for allowing the insertion of the support portion 851b of the air nozzle 851, thereby sealing the gap between the support portion 851b and the bottom wall 821b.

The first carrying means 16 and the second carrying means 17 will now be described with reference to FIG. 1. The first carrying means 16 is located equidistant from the temporary setting table 15, the protective film forming apparatus 7, and the cleaning means 8. The first carrying means 16 may have the same configuration as that of any carrying means generally used. That is, the first carrying means 16 is composed of holding means 161 for holding the annular frame 11 under suction and supporting means 162 for supporting the holding means 161 so that the holding means 161 can be vertically moved and horizontally swiveled. The first carrying means 16 functions to carry the semiconductor wafer 10 (attached to the protective tape 12 supported to the annular frame 11) from the temporary setting table 15 to the protective film forming apparatus 7 before processing and also to carry the semiconductor wafer 10 (attached to the protective tape 12 supported to the annular frame 11) from the cleaning means 8 to the temporary setting table 15 after processing.

The second carrying means 17 is located equidistant from the chuck table 3, the protective film forming apparatus 7, and the cleaning means 8. The second carrying means 17 may have substantially the same configuration as that of the first carrying means 16. That is, the second carrying means 17 is composed of holding means 171 for holding the annular frame 11 under suction and supporting means 172 for supporting the holding means 171 so that the holding means 171 can be vertically moved and horizontally swiveled. The second carrying means 17 functions to carry the semiconductor wafer 10 (attached to the protective tape 12 supported to the annular frame 11) from the protective film forming apparatus 7 to the chuck table 3 before processing and also to carry the semiconductor wafer 10 (attached to the protective tape 12 supported to the annular frame 11) from the chuck table 3 to the cleaning means 8 after processing.

The operation of the laser processing system shown in FIG. 1 will now be described. The semiconductor wafer 10 supported through the protective tape 12 to the annular frame 11 as shown in FIG. 1 (which will be hereinafter referred to simply as the semiconductor wafer 10) is stored at a predetermined position in the cassette 13 in the condition where the front side 10a (work surface) of the semiconductor wafer 10 is oriented upward. The cassette table 131 is next lifted or lowered by the lifting means (not shown) to thereby move the semiconductor wafer 10 stored in the cassette 13 to an ejecting position where the semiconductor wafer 10 is ejected from the cassette 13. The work ejecting/inserting means 14 is next operated to eject the semiconductor wafer 10 from the cassette 13 and to move the semiconductor wafer 10 from the ejecting position to the temporary setting table 15. The semiconductor wafer 10 moved to the temporary setting table 15 is set to a predetermined central position (centrally positioning step).

The semiconductor wafer 10 thus centrally positioned on the temporary setting table 15 is next held under suction by the holding means 161 of the first carrying means 16 and carried onto the vacuum chuck 711a of the spinner table 711 of the protective film forming apparatus 7 by the swiveling action of the holding means 161 about the axis of the supporting means 162. The semiconductor wafer 10 placed on the vacuum chuck 711a is held under suction on the vacuum chuck 711a by the suction means (wafer holding step). Further, the annular frame 11 is fixed by the clamps 714. At this time, the spinner table 711 is set at the load/unload position shown in FIG. 3, and both of the spray nozzle 740 and the liquid resin supply nozzle 750 are set at their standby positions where they are retracted from the spinner table 711 as shown in FIGS. 2 and 3.

After performing the above-mentioned wafer holding step to hold the semiconductor wafer 10 on the spinner table 711 of the protective film forming apparatus 7, a spray coating step is performed in such a manner that the first liquid resin is sprayed onto the work surface of the semiconductor wafer 10 held on the spinner table 711 as rotating the spinner table 711 at a first rotational speed. More specifically, the spinner table 711 is set to the working position shown in FIG. 4, and the electric motor 745 of the spraying means 74 is operated to swing the spray nozzle 740 about the axis of the support portion 742 so that the front end of the nozzle portion 741 comes to a position directly above the center of the front side 10a (work surface) of the semiconductor wafer 10 held on the spinner table 711 as shown in FIG. 11. Next, the electric motor 712 is operated to rotate the spinner table 711 at 50 to 60 rpm (the first rotational speed). Accordingly, the semiconductor wafer 10 held on the spinner table 711 (in the condition where the semiconductor wafer 10 is attached to the protective tape 12 supported to the annular frame 11) is rotated in the direction shown by an arrow 70 in FIG. 11.

In the condition where the semiconductor wafer 10 is being rotated as mentioned above, the first liquid resin supplying means 743 and the air supplying means 744 shown in FIG. 5 are operated to spray the first liquid resin from the nozzle portion 741 of the spray nozzle 740 onto the front side 10a (work surface) of the semiconductor wafer 10, thereby coating the front side 10a with the first liquid resin (spray coating step). More specifically, the first liquid resin supplying means 743 is operated to thereby supply polyvinyl alcohol having a viscosity of 3.8 cp as the first liquid resin to the spray nozzle 740 at a rate of 0.05 mL/sec. At the same time, the air supplying means 744 is operated to supply air to the spray nozzle 740 under a pressure of 0.4 MPa. As a result, the polyvinyl alcohol having a viscosity of 3.8 cp supplied to the spray nozzle 740 is atomized by the air supplied to the spray nozzle 740 at the front end of the nozzle portion 741 and directed toward the front side 10a of the semiconductor wafer 10. In this spray coating step, the electric motor 745 is operated to swing the spray nozzle 740 in a predetermined angular range from the position where the front end of the nozzle portion 741 is located directly above the center of the front side 10a of the semiconductor wafer 10 as shown in FIG. 11 to the position where the front end of the nozzle portion 741 is located directly above the outer circumference of the front side 10a of the semiconductor wafer 10. This spray coating step is performed for 60 to 90 seconds (e.g., 80 seconds). Accordingly, in the case that the duration time of the spray coating step is 80 seconds, 4 mL of polyvinyl alcohol is sprayed in the spray coating step. As a result, polyvinyl alcohol having a viscosity of 3.8 cp as the first liquid resin can be uniformly sprayed onto the front side 10a (work surface) of the semiconductor wafer 10, thereby improving the affinity of the second liquid resin to the semiconductor wafer 10 in the subsequent steps.

After performing the spray coating step mentioned above, a liquid resin supplying step is performed in such a manner that the second liquid resin in a predetermined amount is dropped onto the central area of the work surface of the semiconductor wafer 10 held on the spinner table 711 as rotating the spinner table 711 at a second rotational speed lower than the first rotational speed. More specifically, the electric motor 745 of the spraying means 74 is operated to return the spray nozzle 740 to the standby position shown in FIG. 4, and the electric motor 755 of the liquid resin supplying means 75 is operated to swing the liquid resin supply nozzle 750 about the axis of the support portion 752 so that the front end of the nozzle portion 751 comes to a position directly above the center of the front side 10a (work surface) of the semiconductor wafer 10 held on the spinner table 711 as shown in FIG. 12. Next, the electric motor 712 is operated to rotate the spinner table 711 at 5 to 15 rpm (e.g., 10 rpm) (the second rotational speed).

Accordingly, the semiconductor wafer 10 held on the spinner table 711 (in the condition where the semiconductor wafer 10 is attached to the protective tape 12 supported to the annular frame 11) is rotated in the direction shown by an arrow 70 in FIG. 12. In the condition where the semiconductor wafer 10 is being rotated as mentioned above, the second liquid resin supplying means 753 shown in FIG. 6 is operated to drop the second liquid resin from the nozzle portion 751 of the liquid resin supply nozzle 750 onto the front side 10a (work surface) of the semiconductor wafer 10. More specifically, the second liquid resin supplying means 753 is operated to thereby supply polyvinyl alcohol having a viscosity of 60 cp as the second liquid resin to the liquid resin supply nozzle 750 at a rate of 5 mL/sec. Accordingly, a predetermined amount of liquid resin 100 as the second liquid resin is dropped from the nozzle portion 751 onto the central area of the front side 10a (work surface) of the semiconductor wafer 10 (liquid resin supplying step). This liquid resin supplying step is performed for two to four seconds (e.g., three seconds). Accordingly, in the case that the duration time of the liquid resin supplying step is three seconds, 15 mL of polyvinyl alcohol is supplied in the liquid resin supplying step.

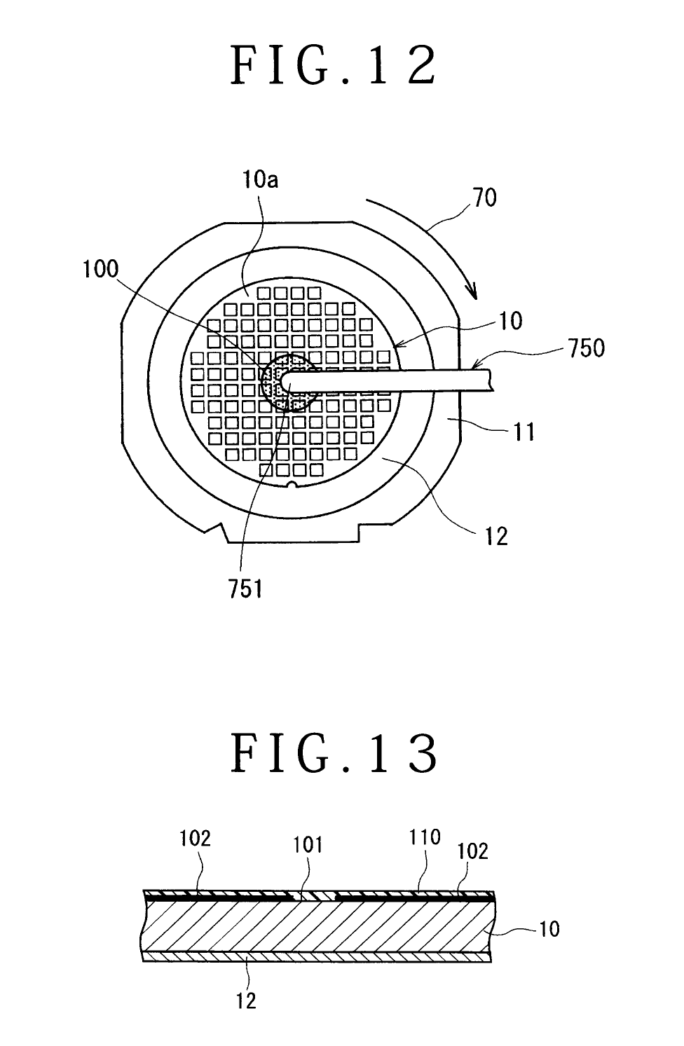

After performing the liquid resin supplying step mentioned above, a spin coating step is performed in such a manner that the spinner table 711 holding the semiconductor wafer 10 thereon is rotated at a third rotational speed higher than the first rotational speed to thereby spread the second liquid resin dropped onto the central area of the front side 10a (work surface) of the semiconductor wafer 10. In this spin coating step, the spinner table 711 is rotated at 400 to 600 rpm (e.g., 500 rpm) (the third rotational speed) for 20 to 40 seconds (e.g., 30 seconds). As a result, a protective film 110 is formed on the front side 10a (work surface) of the semiconductor wafer 10 as shown in FIG. 13. The protective film 110 has a thickness of 5 μm in the case that the spray coating step, the liquid resin supplying step, and the spin coating step are performed on the semiconductor wafer 10 having a diameter of 300 mm. By performing the spray coating step prior to the spin coating step, the affinity of the second liquid resin to the front side 10a of the semiconductor wafer 10 can be improved. Accordingly, although the rotational speed of the spinner table 711 holding the semiconductor wafer 10 thereon in the spin coating step is set lower than that in the conventional method mentioned above, the protective film 110 can be uniformly formed on the front side 10a (work surface) of the semiconductor wafer 10. Accordingly, the rate of contribution of the second liquid resin to the protective film 110 can be improved to thereby reduce the amount of usage of the second liquid resin.

After performing the spin coating step, a spin drying step is performed in such a manner that the spinner table 711 holding the semiconductor wafer 10 is rotated at 2000 to 3000 rpm for 50 to 70 seconds. By performing this spin drying step, the protective film 110 formed on the front side 10a (work surface) of the semiconductor wafer 10 can be quickly dried. Alternatively, this spin drying step may be replaced by a natural drying step.

After performing the spin drying step mentioned above, the spinner table 711 is lifted to the load/unload position shown in FIG. 3 and the vacuum chuck to the semiconductor wafer 10 held on the spinner table 711 is canceled. Next, the semiconductor wafer 10 is held under suction by the holding means 171 of the second carrying means 17 and carried from the spinner table 711 to the vacuum chuck 32 of the chuck table 3 by the swiveling motion of the holding means 171 about the axis of the supporting means 172. The semiconductor wafer 10 thus carried to the vacuum chuck 32 is held on the vacuum chuck 32 under suction. Next, the chuck table 3 holding the semiconductor wafer 10 is moved to a position directly below the imaging means 5 disposed at the laser beam applying means 4 by moving means not shown in the figures.

When the chuck table 3 is positioned directly below the imaging means 5 as mentioned above, the imaging means 5 and the control means not shown in the figures perform image processing such as pattern matching for aligning each street 101 extending in a first predetermined direction on the front side 10a of the semiconductor wafer 10 to the focusing means 42 of the laser beam applying means 4 for applying a laser beam along each street 101. Thus, the alignment of a laser beam applying position to each street 101 extending in the first predetermined direction is performed. Similarly, the alignment of a laser beam applying position to each street 101 extending in a second predetermined direction perpendicular to the first predetermined direction is also performed. In the case that the protective film 110 formed on the front side 10a of the semiconductor wafer 10 is not transparent, infrared radiation for imaging may be applied to the front side 10a of the semiconductor wafer 10 to perform the alignment from the front side 10a.

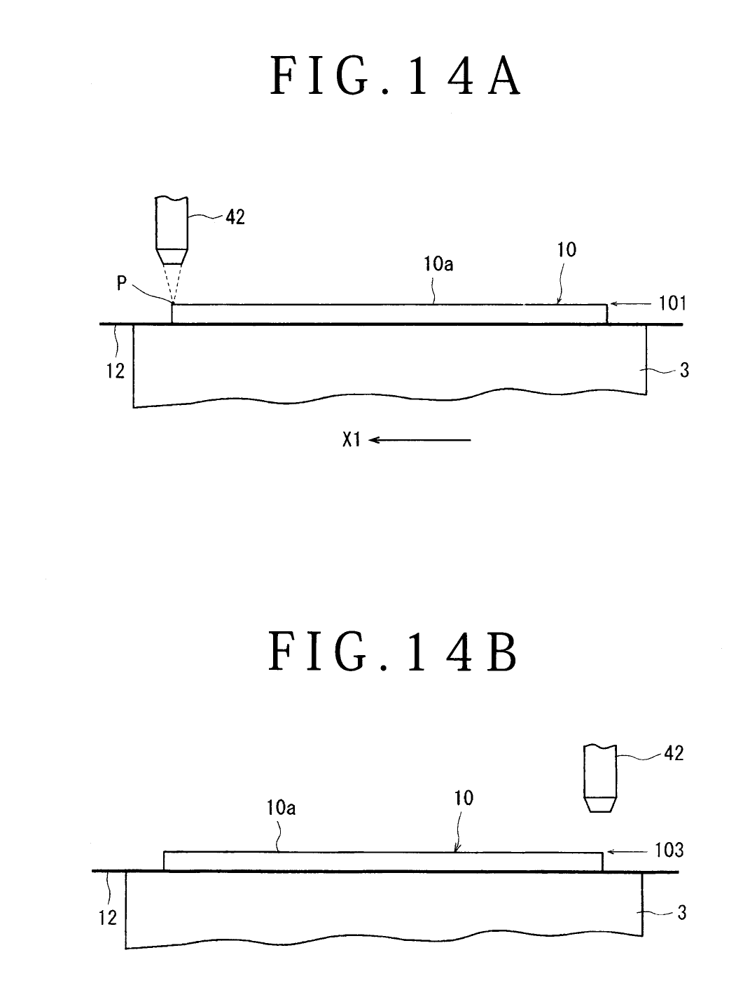

After performing the alignment of the laser beam applying position to detect all the streets 101 formed on the front side 10a of the semiconductor wafer 10 held on the chuck table 3, the chuck table 3 is moved to a laser beam applying region where the focusing means 42 of the laser beam applying means 4 is located, and a predetermined one of the streets 101 extending in the first predetermined direction is positioned directly below the focusing means 42. At this time, the semiconductor wafer 10 is set so that one end (left end as viewed in FIG. 14A) of this predetermined street 101 is positioned directly below the focusing means 42 as shown in FIG. 14A. Thereafter, a pulsed laser beam having an absorption wavelength to the semiconductor wafer 10 is applied from the focusing means 42 of the laser beam applying means 4 to the front side 10a of the semiconductor wafer 10 as moving the chuck table 3 holding the semiconductor wafer 10 in the direction shown by an arrow X1 in FIG. 14A at a predetermined feed speed (laser beam applying step). When the other end (right end as viewed in FIG. 14B) of the predetermined street 101 comes to a position directly below the focusing means 42 as shown in FIG. 14B, the application of the pulsed laser beam is stopped and the movement of the chuck table 3 is also stopped. As shown in FIG. 14A, the focal point P of the pulsed laser beam is set near the upper surface of the predetermined street 101.

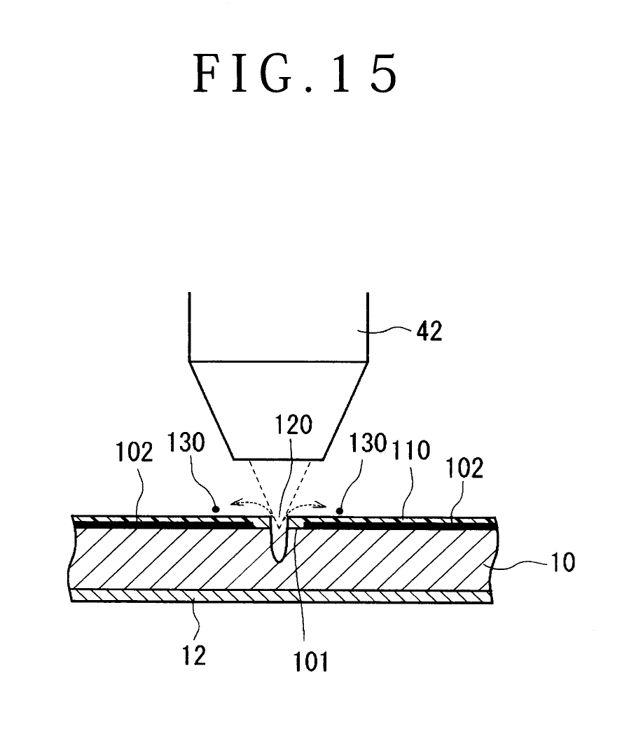

By performing this laser beam applying step, a laser processed groove 120 is formed along the predetermined street 101 as shown in FIG. 15. At this time, even when debris 130 is generated by the application of the pulsed laser beam as shown in FIG. 15, the debris 130 is blocked by the protective film 110, so that the debris 130 is prevented from sticking to the devices 102 and bonding pads (not shown). This laser beam applying step is performed for all of the streets 101 formed on the front side 10a of the semiconductor wafer 10 to thereby form the laser processed groove 120 along each street 101.

For example, the laser beam applying step is performed under the following processing conditions.

Light source of laser beam: YVO4 laser or YAG laser

Wavelength: 355 nm

Repetition frequency: 20 kHz

Power: 3 W

Focused spot diameter: 5 μm

Work feed speed: 100 mm/sec

After performing the laser beam applying step along all of the streets 101 of the semiconductor wafer 10, the chuck table 3 holding the semiconductor wafer 10 thereon is returned to the initial position shown in FIG. 1 and the vacuum chuck to the semiconductor wafer 10 is canceled. Thereafter, the semiconductor wafer 10 is held under suction by the holding means 171 of the second carrying means 17 and carried from the chuck table 3 to the vacuum chuck 811a of the spinner table 811 of the cleaning means 8 by the swiveling motion of the holding means 171 about the axis of the supporting means 172. The semiconductor wafer 10 thus carried to the vacuum chuck 811a is held under suction. At this time, both of the cleaning water nozzle 841 and the air nozzle 851 are set at their standby positions retracted from the spinner table 811 as shown in FIGS. 7 and 8.

In the condition where the semiconductor wafer 10 is held on the spinner table 811 of the cleaning means 8 after processing, a cleaning step is performed in such a manner that the spinner table 811 is lowered to the working position shown in FIG. 9 and the electric motor 842 of the cleaning water supplying means 84 is driven to move the front end of the nozzle portion 841a of the cleaning water supply nozzle 841 to the position directly above the center of the semiconductor wafer 10 held on the spinner table 811. Thereafter, the spinner table 811 is rotated at 300 to 500 rpm, for example, and the cleaning water composed of pure water and air is discharged from the front end of the nozzle portion 841a. The nozzle portion 841a is provided by a so-called two-fluid nozzle such that about 0.2 MPa of pure water and about 0.3 to 0.5 MPa of air are supplied and the pure water is sprayed by the pressure of the air to clean the front side 10a of the semiconductor wafer 10 processed. At this time, the electric motor 842 is driven to swing the nozzle portion 841a of the cleaning water supply nozzle 841 in a required angular range from the center of the semiconductor wafer 10 held on the spinner table 811 to the outer circumference thereof. As a result, the protective film 110 formed on the front side 10a of the semiconductor wafer 10 can be easily cleaned off by the cleaning water because the protective film 110 is formed of a water-soluble resin. At the same time, the debris 130 generated in the laser beam applying step is also removed with the protective film 110.

After performing the cleaning step mentioned above, a drying step is performed in such a manner that the cleaning water supply nozzle 841 is returned to the standby position and the air nozzle 851 of the air supplying means 85 is swung from the standby position shown in FIG. 7 so that the front end of the nozzle portion 851a comes to the position directly above the center of the semiconductor wafer 10 held on the spinner table 811. Thereafter, the spinner table 811 is rotated at 2000 to 3000 rpm, for example, and air is discharged from the front end of the nozzle portion 851a for about 15 seconds. At this time, the nozzle portion 851a of the air nozzle 851 is swung about the axis of the support portion 851b in a required angular range from the center of the semiconductor wafer 10 to the outer circumference thereof. As a result, the front side 10a of the semiconductor wafer 10 is dried.

After performing the drying step mentioned above, the rotation of the spinner table 811 is stopped and the air nozzle 851 of the air supplying means 85 is returned to the standby position. Thereafter, the spinner table 811 is lifted to the load/unload position shown in FIG. 8 and the vacuum chuck to the semiconductor wafer 10 held on the spinner table 811 is canceled. Thereafter, the semiconductor wafer 10 is carried from the spinner table 811 to the temporary setting table 15 by the first carrying means 16. Finally, the semiconductor wafer 10 is carried from the temporary setting table 15 to the cassette 13 and inserted into the predetermined position of the cassette 13 by the work ejecting/inserting means 14.

During the cleaning step and the drying step by the cleaning means 8, the work ejecting/inserting means 14 is operated to eject the semiconductor wafer 10 to be next processed from the cassette 13 to the temporary setting table 15, and the first carrying means 16 is next operated to carry this semiconductor wafer 10 from the temporary setting table 15 to the protective film forming apparatus 7. Thereafter, this semiconductor wafer 10 is subjected to the spray coating step, the liquid resin supplying step, the spin coating step, and the spin drying step by the protective film forming apparatus 7. Thereafter, this semiconductor wafer 10 is carried from the protective film forming apparatus 7 to the chuck table 3 by the second carrying means 17 to perform the laser beam applying step. During this laser beam applying step, the previous semiconductor wafer 10 is carried from the cleaning means 8 to the temporary setting table 15 by the second carrying means 17. Thereafter, the present semiconductor wafer 10 is carried from the chuck table 3 to the cleaning means 8 by the second carrying means 17 to perform the cleaning step and the drying step.

While a specific preferred embodiment of the present invention has been described, the present invention is not limited to this preferred embodiment, but various modifications may be made within the scope of the present invention. For example, while the protective film forming apparatus 7 is incorporated in the laser processing system in this preferred embodiment, the protective film forming apparatus 7 may be configured as an independent apparatus.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A protective film forming method for forming a protective film of resin on a work surface of a wafer, comprising:
a wafer holding step of holding said wafer on a spinner table in the condition where said work surface is oriented upward;
a spray coating step of spraying first liquid resin onto the work surface of said wafer as rotating said spinner table at a first rotational speed after performing said wafer holding step;
a liquid resin supplying step of dropping a predetermined amount of second liquid resin onto a central area of the work surface of said wafer as rotating said spinner table at a second rotational speed lower than said first rotational speed after performing said spray coating step; and
a spin coating step of rotating said spinner table at a third rotational speed higher than said first rotational speed after performing said liquid resin supplying step to thereby spread said second liquid resin dropped onto the central area of the work surface of said wafer, thus forming said protective film on the work surface of said wafer.

2. The protective film forming method according to claim 1, wherein:
said spray coating step is performed under the conditions where said first liquid resin has a viscosity of 3 to 5 cp, said first liquid resin is sprayed at a rate of 0.04 to 0.06 mL/sec for 60 to 90 seconds, and said first rotational speed of said spinner table is set to 50 to 70 rpm;
said liquid resin supplying step is performed under the conditions where said second liquid resin has a viscosity of 50 to 70 cp, said second liquid resin is dropped at a rate of 4 to 6 mL/sec for two to four seconds, and said second rotational speed of said spinner table is set to 5 to 15 rpm; and
said spin coating step is performed under the conditions where said third rotational speed of said spinner table is set to 400 to 600 rpm and the duration time is set to 20 to 40 seconds.

3. The protective film forming method according to claim 1, further comprising a spin drying step of rotating said spinner table at 2000 to 3000 rpm for 50 to 70 seconds after performing said spin coating step to thereby dry said protective film formed on the work surface of said wafer.

4. A protective film forming apparatus for forming a protective film of resin on a work surface of a wafer, comprising:
a spinner table for holding said wafer thereon;
rotational driving means for rotating said spinner table;
spraying means for spraying first liquid resin onto the work surface of said wafer held on said spinner table; and
liquid resin supplying means for dropping second liquid resin onto a central area of the work surface of said wafer held on said spinner table.
